(19) United States
(12) Patent Application Publication
(10) Pub. No.: US 2011/0021244 A1
(43) Pub. Date: Jan. 27, 2011

(54) TETHERED ANTENNA HAVING SERVICED DEVICE COMMUNICATIONS INTERFACE

(75) Inventors: Jeyhan Karaoguz, Irvine, CA (US); John Walley, Ladera Ranch, CA (US); Vinko Erceg, Cardiff by the Sea, CA (US); Arya Reza Behzad, Poway, CA (US); David Rosmann, Irvine, CA (US); Brima B. Ibrahim, Aliso Viejo, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 12/548,625

(22) Filed: Aug. 27, 2009

Related U.S. Application Data
(60) Provisional application No. 61/227,847, filed on Jul. 23, 2009.

(51) Int. Cl. H04M 1/00; H01Q 3/24; H04B 1/38

(52) U.S. Cl. 455/552.1; 343/876; 455/73; 343/711; 343/718

(57) ABSTRACT

An antenna system includes a wired communications interface, an antenna, and antenna system control circuitry. The wired communications interface is operable to couple to a serviced host device and includes a control interface and an antenna interface. The antenna couples to the antenna interface and has configurable antenna characteristics. The antenna system control circuitry couples to the control interface and to the antenna and is operable to communicate the configurable antenna characteristics to the host device and to configure the antenna based upon communication with the host device. In other constructs the antenna may not be configurable and the antenna characteristics communicated are fixed. The antenna system may further include Radio Frequency (RF) transmit circuitry and/or RF transmit circuitry. Such RF transmit circuitry and RF receive circuitry may be configurable or fixed in its operations.

### CROSS-REFERENCE TO PRIORITY APPLICATION

The present application claims priority to U.S. Provisional Application No. 61/227,847, filed Jul. 23, 2009, which is incorporated herein in its entirety for all purposes.

### BACKGROUND

1. Technical Field

The present invention relates generally to wide band wireless signal operations; and more particular to wideband radio frequency operations.

2. Related Art

Communication systems are known to support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11x, Bluetooth, wireless wide area networks (e.g., WiMAX), advanced mobile phone services (AMPS), digital AMPS, global system for mobile communications (GSM), North American code division multiple access (CDMA), Wideband CDMA, local multi-point distribution systems (LMDS), multi-channel-multi-point distribution systems (MMDS), radio frequency identification (RFID), Enhanced Data rates for GSM Evolution (EDGE), General Packet Radio Service (GPRS), and many others.

Depending on the type of wireless communication system, a wireless communication device, such as a cellular telephone, two-way radio, personal digital assistant (PDA), personal computer (PC), laptop computer, home entertainment equipment, RFID reader, RFID tag, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system or a particular RF frequency for some systems) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, the receiver is coupled to an antenna and includes a low noise amplifier, one or more intermediate frequency stages, a filtering stage, and a data recovery stage. The low noise amplifier receives inbound RF signals via the antenna and amplifies then. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

As is also known, the transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

Many wireless transceivers are able to support multiple communication standards, which may be in the same frequency band or in different frequency bands. For example, a wireless transceiver may support Bluetooth communications for a personal area network and IEEE 802.11 communications for a Wireless Local Area Network (WLAN). In this example, the IEEE 802.11 communications and the Bluetooth communications may be within the same frequency band (e.g., 2.4 GHz for IEEE 802.11b, g, etc.). Alternatively, the IEEE 802.11 communications may be in a different frequency band (e.g., 5 GHz) than the Bluetooth communications (e.g., 2.4 GHz).

A transceiver that supports multiple standards typically includes multiple RF front-ends (e.g., on the receiver side, separate LNA, channel filter, and IF stages for each standard and, on the transmitter side, separate IF stages, power amplifiers, and channels filters for each standard). As such, multiple standard transceivers typically include multiple separate RF front-ends; one for each standard in a different frequency band, channel utilization scheme (e.g., time division multiple access, frequency division multiple access, code division multiple access, orthogonal frequency division multiplexing, etc.), and/or data modulation scheme (e.g., phase shift keying, frequency shift keying, amplitude shift keying, combinations and/or variations thereof). Differing communication protocol standards typically support communications within differing frequency bands. Antennas and/or RF front-ends that adequately service communications within one frequency band may not adequately service communications within one or more other frequency bands. Further, even though the antennas and/or RF front-ends may marginally service communications within multiple frequency bands, amplification performance and/or energy consumption for the service of communications with some of these frequency bands may be unacceptable.

Therefore, a need exists for a wireless device that is capable of at least partially overcoming one or more of the above mentioned multiple standard limitations.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a system diagram illustrating a wireless communication system constructed and operating according to one or more embodiments of the present invention;

FIG. 2A is a block diagram illustrating an embodiment of an antenna system constructed according to one or more embodiments of the present invention and components of a host device coupled thereto;

FIG. 2B is a block diagram illustrating another embodiment of an antenna system constructed according to one or more embodiments of the present invention and components of a host device coupled thereto;

FIG. 2C is a block diagram illustrating another embodiment of an antenna system constructed according to one or more embodiments of the present invention and components of a host device coupled thereto;

FIG. 3 is a signal diagram illustrating operation upon various information signals according to one or more embodiments of the present invention;

FIG. 4 is a block diagram illustrating transmitter section component of the host device or of the antenna system constructed according to one or more embodiments of the present invention;

FIG. 5 is a block diagram illustrating a receiver section of an antenna system or host device constructed according to one or more embodiments of the present invention;

FIGS. 6A-6D are diagrams illustrating adjustable properties of an antenna structure constructed in accordance with one or more embodiments of the present invention;

FIG. 7 is a diagram illustrating an embodiment of a configurable antenna in accordance with one or more embodiments of the present invention;

FIGS. 8A and 8B are diagrams illustrating configured antennas in accordance with one or more embodiments of the present invention;

FIGS. 9A and 9B are diagrams illustrating configured antennas in accordance with one or more embodiments of the present invention;

FIG. 10 is a block diagram illustrating an antenna system constructed according to the present invention that services a plurality of host devices;

FIG. 11 is a flow chart illustrating operation of an antenna system according to an embodiment of the present invention;

FIG. 12 is a flow chart illustrating operation of an antenna system according to another embodiment of the present invention;

FIG. 13 is a flow chart illustrating operation of an antenna system according to yet another embodiment of the present invention; and

FIG. 14 is a block diagram illustrating structure for coupling RF signals between a host device and an antenna system according to one or more embodiments of the present invention.

### DETAILED DESCRIPTION OF THE DRAWINGS

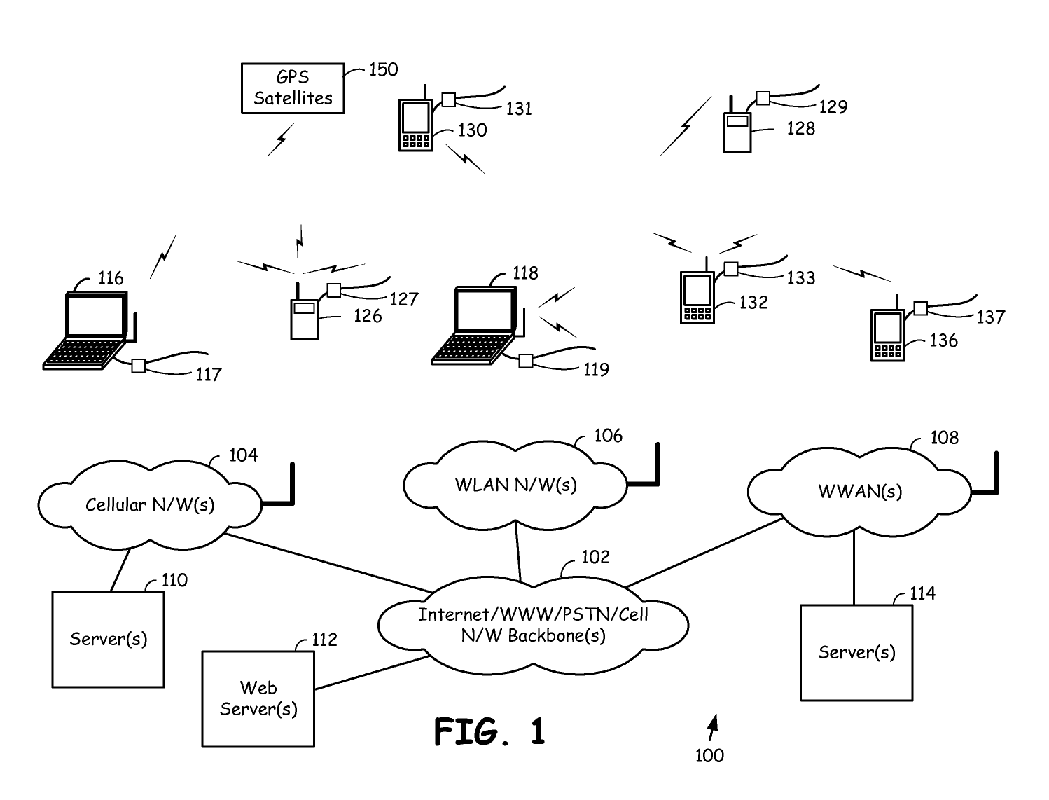

FIG. 1 is a system diagram illustrating a wireless communication system constructed and operating according to one or more embodiments of the present invention. The wireless communication system 100 of FIG. 1 includes a communication infrastructure and a plurality of wireless devices. The communication infrastructure includes one or more cellular networks 104, one or more wireless local area networks (WLANs) 106, and one or more wireless wide area networks (WWANs) 108. The cellular networks 104, WLANs 106, WWANs 108 all typically couple to one or more backbone networks. The backbone networks 102 may include the Internet, the Worldwide Web, one or more public switched telephone network backbones, one or more cellular network backbones, one or more private network backbones and/or other types of backbones that support communications with the various wireless network infrastructures 104, 106, and 108. Server computers may couple to these various network infrastructures. For example, server computer 110 couples to cellular network 104, web server 112 couples to the Internet/WWW/PSTN/Cell network 102, and server 114 couples to WWAN network 108. Other devices may couple to these networks as well in various other constructs.

Each of the cellular networks 104, WLANs 106, and WWANs 108 support wireless communications with wireless devices in various wireless spectra and according to various communication protocol standards. For example, the cellular network 104 may support wireless communications with wireless devices within the 800 MHz band and the 1900 MHz band, and/or other Radio Frequency (RF) bands that are allocated for cellular network communications. The cellular network 104 may support GSM, EDGE, GPRS, 3G, CDMA, TDMA, and/or various other standardized communications. Of course, these are examples only and should not be considered to limit the spectra or operations used by such cellular networks. The WLANs 106 typically operate within the Industrial, Scientific, and Medical (ISM) bands that include the 2.4 GHz and 5.8 GHz bands. The ISM bands include other frequencies as well that support other types of wireless communications, such bands including the 6.78 MHz, 13.56 MHz, 27.12 MHz, 40.68 MHz, 433.92 MHz, 915 MHz, 24.125 GHz, 61.25 GHz, 122.5 GHz, and 245 GHz bands. The WWANs networks 108 may operate within differing RF spectra based upon that which is allocated at any particular locale.

The wireless network infrastructures 104, 106, and 108 support communications to and from wireless devices 116, 118, 128, 130, 132, and/or 136. Various types of wireless devices are illustrated. These wireless devices include laptop computers 116 and 118, cellular telephones 126 and 128, portable data terminals 130, 132, and 136. Of course, differing types of devices may be considered wireless devices within the context of the scope of the present invention. For example, automobiles themselves having cellular interfaces would be considered wireless devices according to the present invention. Further, any device having a wireless communications interface either bi-directional or uni-directional, may be considered a wireless device according to the present invention, in various other types of wireless devices. For example, wireless devices may include Global Positioning System (GPS) receiving capability to receive positioning signals from multiple GPS satellites 150.

The wireless devices 116-136 may support peer-to-peer communications as well, such peer-to-peer communications not requiring the support of a wireless network infrastructure. For example, these devices may communicate with each other in a 60 GHz spectrum, may use a peer-to-peer communications within a WLAN spectrum, for example, or may use other types of peer-to-peer communications. For example, within the ISM spectra, wireless devices may communicate according to Bluetooth protocol or any of the various available WLAN protocols supported by IEEE802.11x, for example.

Each of the wireless devices (host devices) 116-136 is coupled to an antenna system constructed according to one or more embodiments of the present invention. The antenna system includes a wired communications interface that is operable to couple to a respective serviced host device. For example, host device 116 couples to antenna system 117, host device 118 couples to antenna system 119, host device 126 couples to antenna system 127, host device 128 couples to antenna system 129, host device 130 couples to antenna system 131, host device 132 couples to antenna system 133, and host device 136 couples to antenna system 137.

The host devices may couple to their respective antenna systems via various types of wired communications interfaces. Such wired communications interfaces may be one or more of serial interfaces (e.g., USB interface, Firewire, RS-232, RS-422, RS-423, RS-449, etc.), parallel wired interfaces (LPT type port), or another type of wired interface that allows the antenna system to communicate with the host device as well as to couple RF communications there between. Other types of wired interfaces may include expansion card interfaces, Hard Disk Drive (HDD) interfaces, peripheral device interfaces, and other types of wired interfaces that support communications with the host device. Further, the wired communications interface may be an optical interface as well.

Each of the antenna systems includes a wired communications interface that is operably coupled to the serviced host device, the wired communications interface including a control interface and an antenna interface. The control interface services control communications between the antenna system and the host device. The antenna interface services RF, baseband, and/or IF communications between the antenna system and the service host device. Various embodiments of the wired communications interface will be described further herein. The wired communications interface may include a wave guide in some embodiments to efficiently couple RF signals between the host device and the antenna system. In such embodiment, the wave guide may be formed about signal lines that operate according to standard communication protocol(s) such as USB 2.0, Firewire, RS-232, etc.

In some embodiments, the antenna system receives power from the host device via a powered wired communications interface of the host device. For example, USB ports generally provide power to peripheral devices and, with such embodiment, the antenna system receives power via the USB port.

The antenna system further includes an antenna that couples to the antenna interface. The antenna may be configurable or have a fixed configuration. Various embodiments of the antenna will be described further herein with reference to subsequent FIGs. The antenna system further includes antenna system control circuitry that couples to the control interface and to the antenna. The antenna system control circuitry is operable to communicate antenna characteristics or other characteristics of the antenna system to the host device and to configure the antenna and/or other components of the of the antenna system, e.g., RF circuitry of the antenna system, antenna tuning circuitry, and/or a combination of these and various embodiments of the antenna system based upon communications had with the host device.

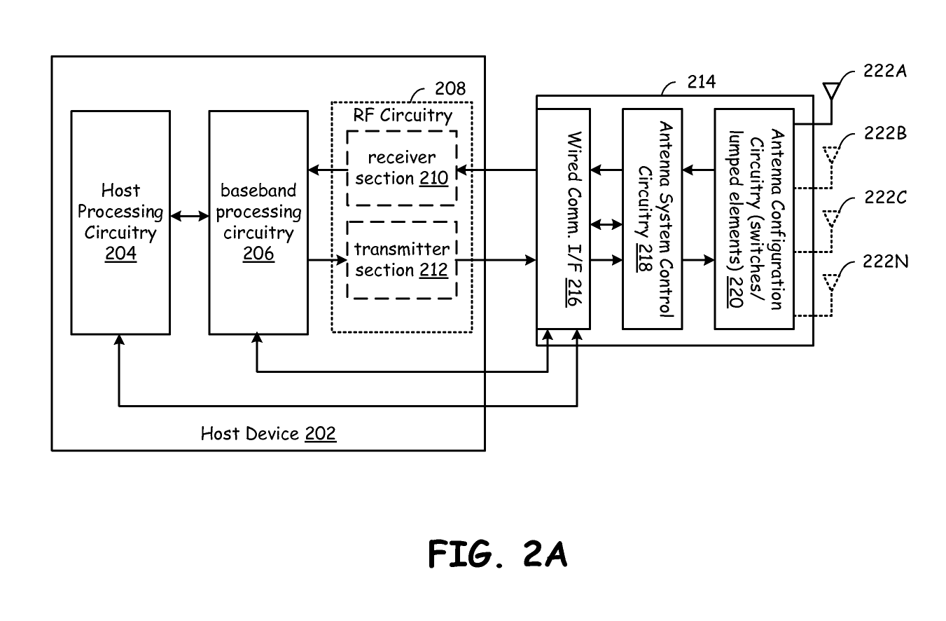

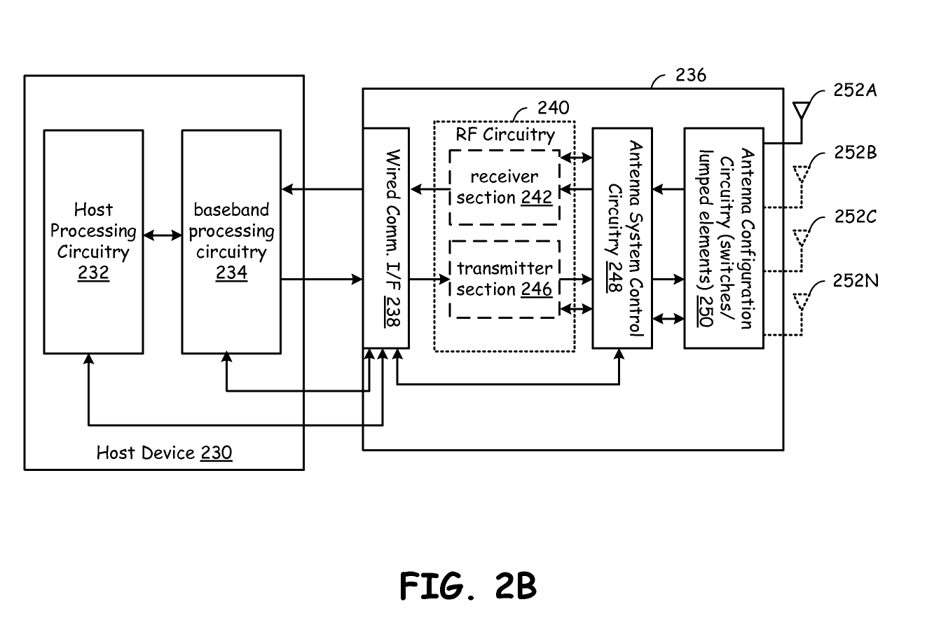

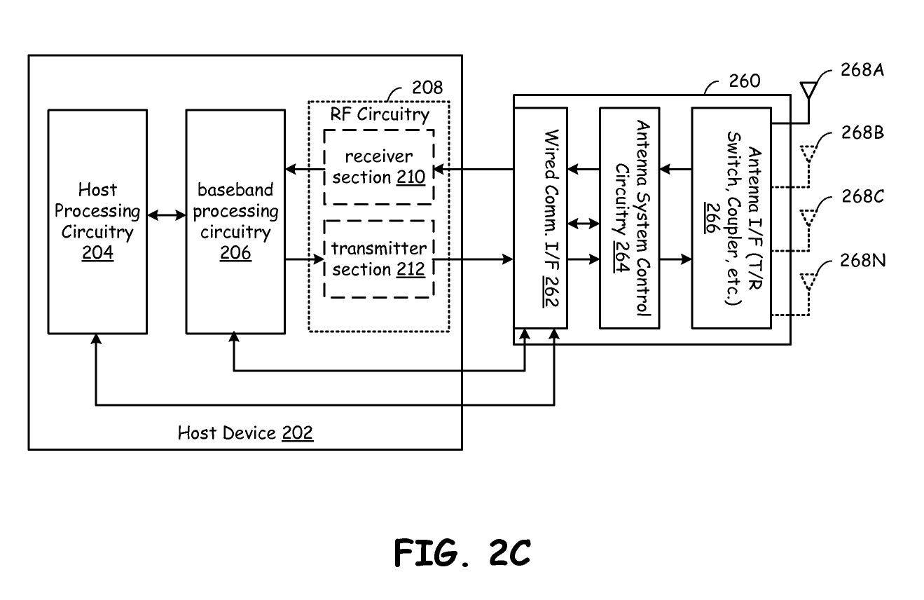

FIG. 2A is a block diagram illustrating an embodiment of an antenna system constructed according to one or more embodiments of the present invention and components of a host device coupled thereto. The host device 202 may be any of the various host devices 116-136 illustrated in FIG. 1. The host device 202 includes host processing circuitry 204, baseband processing circuitry 206, and RF circuitry 208, was well as additional components that are not illustrated in FIG. 2A, e.g., memory, user interface(s), special processing modules, other interfaces, etc. The host processing circuitry 204 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module may have an associated memory and/or memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Further note that when the processing module implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element stores, and the processing module executes, hard coded and/or operational instructions corresponding to at least some of the steps and/or functions illustrated in the FIGs.

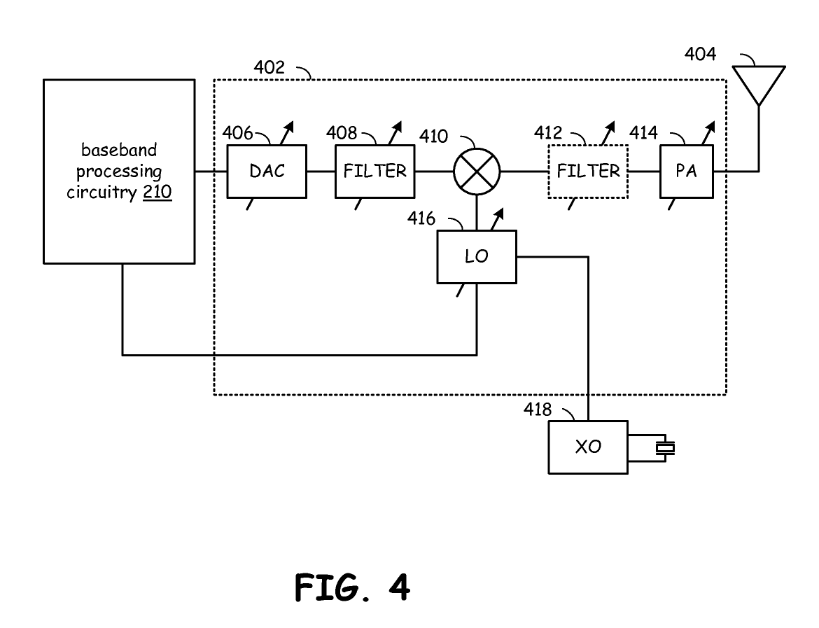

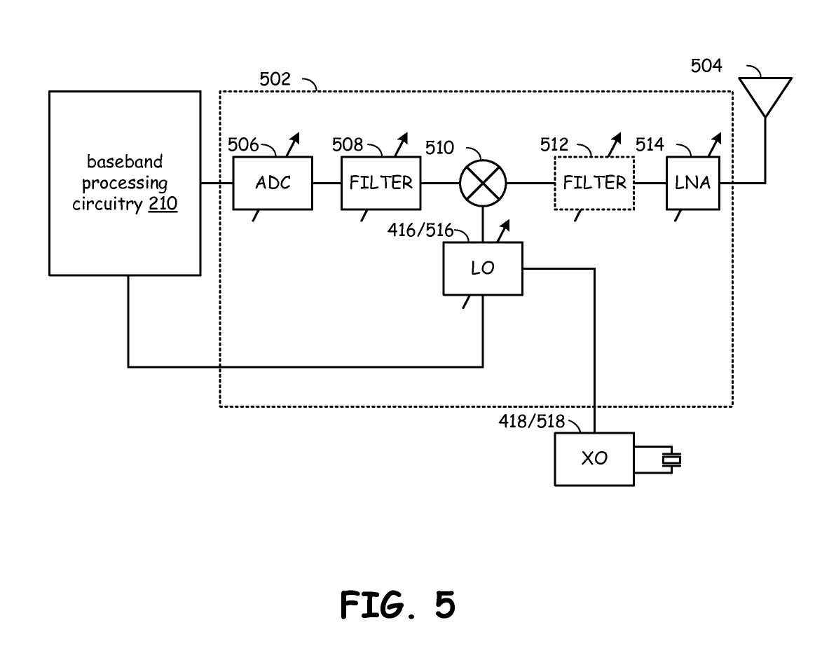

Baseband processing circuitry 206 is generally known in the art to support communications for the host device 202. The baseband processing circuitry 206 may include a DSP, specialized circuitry, or generalized circuitry that is programmed to perform baseband processing operations. RF circuitry 208 couples to baseband processing circuitry 206 and includes the receiver section 210 of the transmitter section 212. Components of the receiver section 212 in the transmitter section 212 will be described further herein with reference to FIGS. 4 and 5.

The antenna system 214 couples to host device 202 via the RF circuitry 208 and/or one or more of wired communications with baseband processing circuitry 206 and host processing circuitry 204. Thus, the wired communications interface 216 includes RF communication link or links and control communications path or paths. The antenna system 214 further includes antenna system control circuitry 218 and antenna configuration circuitry 220. With the embodiment of FIG. 2A, the antenna configuration circuitry is operable to configure one or more antennas 222A-222N. With the embodiment of FIG. 2A, the antenna has configurable antenna characteristics. Such configurable antenna characteristics may be based upon multiple antenna elements 222A-222N, inter-coupling switches and/or lumped elements for tuning of the antenna to control its RF characteristics.

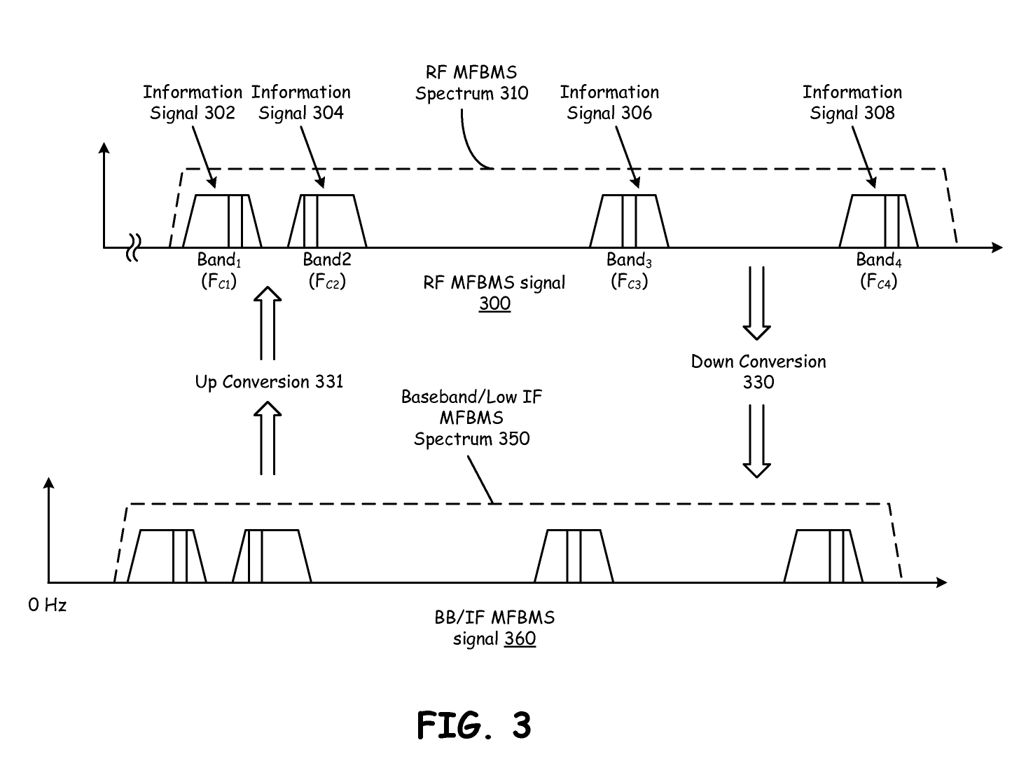

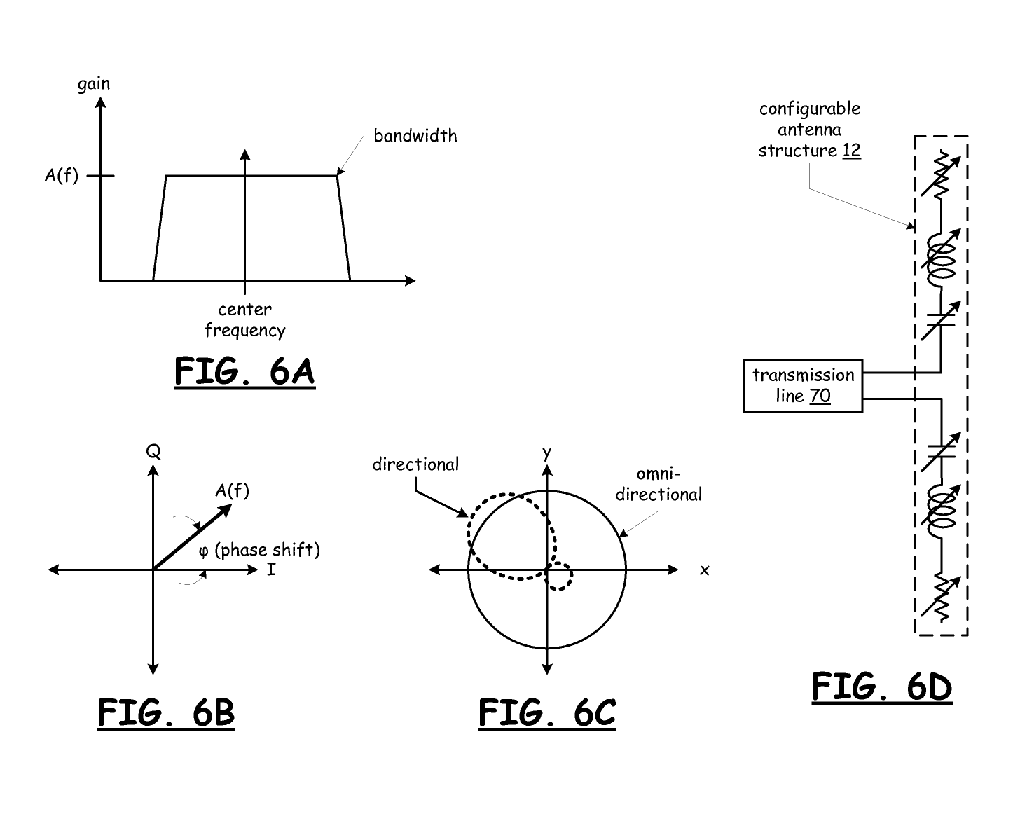

The antenna system 214 communicates configurable antenna characteristics to host device 202 via a control interface of the wired communications interface 216. The antenna system 214 then communicates with host device 202 to determine a configuration for the antenna of the antenna system 214. The antenna system control circuitry 218 in conjunction with the antenna configuration circuitry 220 configures the antenna of the antenna system based upon the communication of the host device 202. As will be described herein in detail with reference to FIGS. 6A-9, the antenna system may configure a plurality of switches to inter-couple the plurality of antenna elements 222A-222N to set frequency/gain performance characteristics of the antenna system. The manner in which the configuration is performed in order to service signals of various frequency bands will be described further herein with reference to FIGS. 3 and 6A-6D.

Generally, the host device 202 services wireless communications within one or more frequency bands of interest in which information signals are transmitted or received. These information signal frequency bands may include at least one wireless local area network (WLAN) frequency band, at least one wireless personal area network (WPAN) frequency band, at least one cellular frequency band, at least one millimeter wave frequency band, and/or at least one global positioning system (GPS) frequency band. Because each of these frequency bands may be separate and distinct from each other frequency band, the performance of the antenna system 214 is altered to support desired frequency bands. The manner in which the configuration of the antenna system 214 is selected is based upon communication between the host device 202 and the antenna system via the wired communications interface.

Coupling of RF signals between the host device 202 and the antenna system 214 may be via wired conductors suitable to carry RF signals, a waveguide that is formed of a high quality metal, e.g., gold, silver etc., a coaxial connection, or another connection suitable to carry RF signals.

FIG. 2B is a block diagram illustrating another embodiment of an antenna system constructed according to one or more embodiments of the present invention and components of a host device coupled thereto. The antenna system 236 of FIG. 2B includes wired communications interface 238, RF circuitry 240, antenna system control circuitry 248, and antenna configuration circuitry 250. The antenna system 236 furthers one or a plurality of antenna elements 252A, 252B, 252C, and 252N. As contrasted to the embodiment of FIG. 2A, the antenna system 236 of FIG. 2B includes the RF circuitry 240. The RF circuitry 240 includes receiver section 242 and transmitter section 246. Embodiments of the receiver section 242 and transmitter section 246 will be described further herein with reference to FIGS. 5 and 4, respectively.

The antenna system 236 couples to host device 230, which may be any of the various host devices described with reference to FIG. 1. Host device 230 includes host processing circuitry 232 and baseband processing circuitry 234. Of course, in other embodiments, the host device 230 may include additional elements to those as illustrated in FIG. 2B. The wired communications interface 238 couples to baseband processing circuitry 234 and host processing circuitry 232 of host device 230. In its operations, the RF circuitry 240 of antenna system 236 is operates upon baseband/low IF signals to produce RF signals and operates upon RF signals to produce baseband/low IF signals. Particularly, the transmitter section 246 of the antenna system 236 receives baseband/low IF transmit signals from baseband processing circuitry 234 and converts the baseband/low IF signals to RF signals. Further, the receiver section 242 of RF circuitry 240 is operable to receive RF signals from the antenna configuration circuitry 250, to convert the RF signals to baseband/low IF signals, and to couple the baseband/low IF signals to baseband processing circuitry 234 via the wired communications interface 238.

According to the embodiment of FIG. 2B, the receiver section 242 and the transmitter section 246 of RF circuitry 240 are controllable based upon communication with host device 230. For example, the operation of receiver section 242 and transmitter section 246 may be configured based upon the frequency band or bands of information signals upon which the antenna system operates and which host device 230 services. Examples of such operations are further described with reference to FIG. 3 herein.

With the embodiment of FIG. 2B, the antenna configuration circuitry 250 of the antenna system may be operable to configure the antenna of the antenna system 236 that includes the plurality of antenna elements 252A-252N. Further, the antenna configuration circuitry 250 may include tuning elements such as lumped elements and the plurality of switches. The antenna configuration circuitry 250 is operable to configure the lumped elements of the plurality of lumped elements to configure the antenna for particular operations.

With the embodiment of FIG. 2B as well as the embodiment of FIG. 2A, the antenna system may support communications within a plurality of different frequency bands. Further, with the embodiment of FIG. 2B and with the embodiment of FIG. 2A, the antenna system may be operable to selectively enable coupling of the antenna of the antenna system 236 to the host device 230. Thus, based upon the communications with the host device 230, the antenna system may selectively couple the RF circuitry 240 to the baseband processing circuitry 234 to service RF signals for the host device 230. Further, the antenna system 236 selectively decoupled the antenna (and RF circuitry 240) of the antenna system 236 to the host device 230. Further, in some embodiments, some RF communications of the host device 230 may be serviced by antenna system 236 while others may not be serviced by the antenna system. For example, based upon the frequency/gain characteristics of the antenna system 236, the host device 230 may use the antenna system 236 to service wireless communications in some frequency bands while not using the antenna system 236 to service wireless communications in other frequency bands. The manner in which the antenna system 236 communicates its capabilities to the host device 230 and the methodology used by the host device 230 to selectively use the antenna system 236 enables the host device 230 to more efficiently use the antennas it has as its disposal.

Coupling of RF signals between the host device 230 and the antenna system 236 may be via wired conductors suitable to carry RF signals, a waveguide that is formed of a high quality metal, e.g., gold, silver etc., a coaxial connection, or another connection suitable to carry RF signals.

FIG. 2C is a block diagram illustrating another embodiment of an antenna system constructed according to one or more embodiments of the present invention and components of a host device coupled thereto. With the embodiment of FIG. 2C, the antenna system 260 includes wired communications interface 262, antenna system control circuitry 264, and antenna interface 266. The antenna interface 266 couples to one or more antenna elements 268A-268N.

Host device 202 includes host processing circuitry 204, baseband processing circuitry 206, and RF circuitry 208 (among other components). The RF circuitry 208 includes receiver section 210 and transmitter section 212. The RF circuitry 208, baseband processing circuitry 206, and/or host processing circuitry 204 couple to a wired communications interface 262 of the antenna system 260. Communications between antenna system 260 and host device 202 are enabled via the wired communications interface 262. With the embodiment of FIG. 2C, the antenna system control circuitry 264 is operable to communicate antenna characteristics of the antenna system 260 to the host device 202. The host device 202 may then decide whether or not to employ operation of the antenna system 260 for none, some or all RF communications of the host device. The antenna characteristics may include frequency/gain characteristics of the antenna, whether the antenna system 260 has receive path gain circuitry, whether the antenna system 260 has transmit path gain circuitry, and/or various other characteristics of the antenna system. Based upon receipt of the antenna characteristics information, the host device 202 determines whether or not to enable usage of the antenna system 260. Enabling the usage may simply include the host device 202 selectively coupling RF signals to the antenna system 260.

The embodiments of FIGS. 2A, 2B, and 2C include one or more antenna elements that are installed within the structure of a vehicle such as a car, a bus, an airplane, or another type of vehicle. In such case, the structure of the vehicle allows for antenna elements, e.g., 252A-252N to be distributed throughout the structure of the vehicle or attached thereto. With the structure of the automobile, the dimensions of the antennas that are installed in the vehicle will be larger than those available with a handheld device and may be better able to service some or all communications required by the host device 230. Further, with the embodiments of FIGS. 2A, 2B, and 2C, the antenna elements may be installed in the structure of building or worn by a person. In particular, an antenna structure that is worn by a person may be placed in a jacket, a shirt, or a wearable garment the user may plug into his host device 230, such as a cell phone. Thus, when the user puts on such garment, it simply attaches the USB adapter to the host device 230.

With these embodiments, the antenna elements that are available with the antenna system 236 may provide better gain within frequency bands of interest than that which is available within a small host device 230 such as that as a cellular telephone, data terminal, or laptop computer. As the reader will appreciate, by locating antenna elements within a vehicle, building, or within a device worn by a person, the user of the host device 230 may also have lower power consumption due to lower gain requirements of the transmit path and/or receiver path. The host device 230 may automatically enable the antenna system 236 based upon antenna characteristics. Alternately, the host device 230 may interface with the user (via a user interface, such as a graphical user interface) to allow the user to select whether the antenna system is used.

Coupling of RF signals between the host device 202 and the antenna system 260 may be via wired conductors suitable to carry RF signals, a waveguide that is formed of a high quality metal, e.g., gold, silver etc., a coaxial connection, or another connection suitable to carry RF signals.

FIG. 3 is a signal diagram illustrating operation upon various information signals according to one or more embodiments of the present invention. As was previously described, host devices may service communication within a plurality of frequency bands. Each of these frequency bands resides somewhere within the RF spectrum. Illustrated is a plurality of information signals 302, 304, 306, and 308, each of which is potentially governed by a respective communications protocol standard. This RF signal is referred to herein as an RF multiple frequency band multiple standard signal (MFBMS) signal 300 that resides within an RF BMS spectrum 310. At various times or a single time, the host device may desire to communicate within the RF MFBMS spectrum 310 using the plurality of information signals 302, 304, 306, and 308. Generally, the host device converts between a baseband/IF MFBMS signal 360 residing within a baseband/low IF MFBMS spectrum 350 and the RF MFBMS spectrum 310. Such operations performed include up conversion operations 331 and down conversion operations 330.

The number of bands and information signals that are operated upon at any given time will typically vary. For example, at a first time, the host device may operate only upon a single information signal on a single information band. However, at other times, the host device may operate upon multiple information signals at a single time, each of which resides within a respective RF band. Thus, the requirements placed upon an antenna for in servicing the RF MFBMS signal 300 varies over time. The antenna system therefore may be employed at some times, all times, or at no times, such varying usage changing with the various RF signal communication requirements of the host device.

For example, when the host device operates only upon information signal 302 within the RF MFBMS spectrum 310, an onboard antenna (of the host device) may be employed and the antenna system of the present invention may not be required. However, when the host device operates upon information signal 308, the antenna performance offered by the antenna system may be sufficiently better than the host device onboard antenna that the host device chooses to use the antenna system for communications using information signal 308. Further, when operation across a wide frequency spectrum is required, the host device may determine that the antenna system is better suited for operations than an on-board antenna of the host device. Thus, host device employs the antenna system when operating upon multiple information signals that reside across a relatively wide (or full portion) of the RF MFBMS spectrum 310.

FIG. 4 is a block diagram illustrating transmitter section component of the host device or of the antenna system constructed according to one or more embodiments of the present invention. The transmitter section 402 components couples to baseband processing circuitry 210, to an external crystal oscillator 418, and antenna element 404. The transmitter section 402 receives digitized baseband/low IF information signals from baseband processing circuitry 210 and uses a digital-to-analog converter (DAC) 406 to convert the digitized baseband/low IF information signals to analog information signals. Filter 408 then filters the analog information signal. The filtered analog information signal are then up converted using mixer 410 and local oscillation produced by local oscillator 416 to produce RF information signals at the output of mixer 410. The local oscillation changes over time based upon control of another component. RF filter 412 filters the RF information signals and power amplifier (PA) amplifies the RF information signals prior to coupling such signals to antenna 404. Antenna 404 may include a single antenna element or multiple antenna elements that are switched in and out based upon control information from the antenna system control circuitry of the antenna system of the present invention. The structure of FIG. 4 may be part of an antenna system or of the hose device.

FIG. 5 is a block diagram illustrating a receiver section of an antenna system or host device constructed according to one or more embodiments of the present invention. The receiver section 502 couples to an antenna 504 that may include one or more antenna elements. A low noise amplifier 514 receives an incoming RF information signal and amplifies the incoming RF information signal that is then filtered by filter 512. The filtered incoming RF information signal is down converted by mixer 510 based upon local oscillation produced by local oscillator 416/516 to produce a down sampled baseband/low IF information signal. The baseband/low IF information signal is filtered by filter 508 and converted to a digital representation thereof by analog-to-digital converter (ADC) 506. The output of ADC 506 is provided to baseband processing circuitry 210 of the host device. Crystal oscillator 418/518 provides a reference oscillation to local oscillator 416/516 to produce the local oscillation signals for mixer 510. The crystal oscillator 418/518 may be shared with the transmitter section 402 of FIG. 4. The local oscillation changes over time based upon control of another component.

Referring to both FIGS. 4 and 5, the various components of the transmitter section 402 and receiver section 502 may be controlled by the host device, baseband processing circuitry or an antenna control circuitry of the antenna system. At such case, the local oscillation frequency may be controlled, as may be the various gain and filter settings of the components of the transmitter section and receiver section. The manner in which characteristics of components of the receiver section and transmitter section are controlled is generally known and is not described further herein except as it relates to the present invention.

FIGS. 6A-6D are diagrams illustrating adjustable properties of an antenna structure constructed in accordance with one or more embodiments of the present invention. Referring to FIG. 6A, illustrated is an example of the frequency response of a configured antenna. The frequency response includes a gain, which may fixed (A) or adjustable [A(f)], a center frequency, and a bandwidth. The center frequency, which corresponds to the resonant frequency of the antenna, is primarily determined by the length of the antenna (λ=c/f, where λ is the wave length, c is the speed of light, and f is the resonant frequency). As such, the antenna components may be configured to provide an antenna that has a specific length to provide a desired center, or resonant, frequency. Alternatively, the antenna components may be configure to provide a length that is a fraction of the length of the desired frequency such that the antenna resonates at a harmonic frequency, or frequencies, of the desired frequency. Further, the antenna components may be configured to provide multiple resonant frequencies, which enable the antenna to be effective over a wide range of frequencies.

The gain of an antenna is generally defined as the ratio of the intensity, which is a function of per unit surface, radiated by the antenna in a given direction at a distance divided by the intensity radiated at the same distance by a hypothetical isotropic antenna. As such, by configuring the antenna components in a way that affects the per unit surface of the antenna, the gain of the antenna can be set, or adjusted.

The bandwidth of an antenna having a length of ½ wavelength or less is primarily dictated by the antenna's quality factor (Q), which may be mathematically expressed as shown in Eq. 1 where v₀ is the resonant frequency, 2δv is the difference in frequency between the two half-power points (i.e., the bandwidth).

$$\frac{{v}_{0}}{2 \partial v} = \frac{1}{Q} \qquad Equation 1$$

Equation 2 provides a basic quality factor equation for the antenna structure, where R is the resistance of the antenna structure, L is the inductance of the antenna structure, and C is the capacitor of the antenna structure.

$$Q = \frac{1}{R} * \sqrt{\frac{L}{C}} \qquad Equation 2$$

As such, by adjusting the resistance, inductance, and/or capacitance of an antenna structure, the bandwidth can be controlled.

FIG. 6B illustrates an example of phase shifting a signal transmitted or received by a configured antenna. In this instance, the transmitted or received signal is represented by the term [A(f)], which may be rotated in phase by a φ (phase shift) value. In an embodiment, the antenna components 24 include one or more phase shifters that phase shift a transmitted or received signal.

FIG. 6C illustrates an example of an antenna's directional capabilities. As shown, an antenna may be omni-directional or directional. As such, the antenna components may be configured to provide an antenna that has a directional radiation pattern or one that has a more omni-directional radiation pattern.

FIG. 6D illustrates a configurable antenna structure 12 coupled to a transmission line 70. In this diagram, the antenna components may be configured in a variety of ways to provide a desired resistance, inductance, and/or capacitance. From configuration to configuration, the resistance, inductance, and/or capacitance may be changed to affect one or more properties of a configured antenna. As such, the configurable antenna structure 12 can be configured to provide an antenna, or antennas, for a desired level of operation for one or more standards in one or more frequency bands.

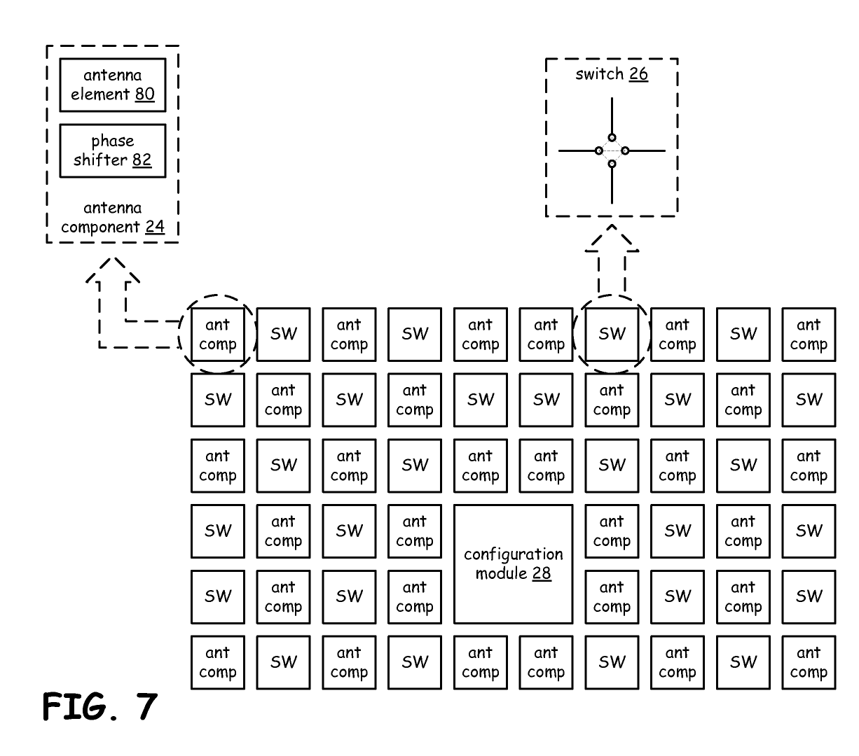

FIG. 7 is a diagram illustrating an embodiment of a configurable antenna in accordance with one or more embodiments of the present invention. The configurable antenna structure of FIG. 7 includes a plurality of antenna components 24 (ant comp) and a plurality of switches 26 (SW). The antenna components 24 and switches may be viewed and/or arranged in a series of rows and columns, or other patterns to provide various options for configuring antennas having desired properties.

As shown, an antenna component 24 may include an antenna element 80 and/or a phase shifter 82. The antenna element may 80 be a trace of a specific geometric shape (e.g., square, rectangle, right angle, arc, etc.) having a length, width, and depth to provide, at a frequency, a resistance, inductance, and/or capacitance. Note that the capacitance is with respect to another antenna component or antenna element.

A phase shifter 82 may be a trace that is inductively and/or capacitively coupled to an antenna element, or elements, that changes the phase of the transmitted or received signal. In another embodiment, the phase shifter 82 may include a capacitor, an inductor, a transistor, and/or resistor to phase shift a received or transmitted signal. In yet another embodiment, the phase shifter 82 may be a circuit (e.g., filter, integrator, differentiator, etc.) that shifts the phase of a transmitted or received signal.

A switch 26 of the plurality of switches may include a plurality of connection lines and a plurality of switches that connect one of the connection lines to another. With the switches 26 distributed among the antenna components 24, the antenna components may be coupled together to provide a variety of configured antennas. Note that a switch 26 may have more or less than the four connect lines shown.

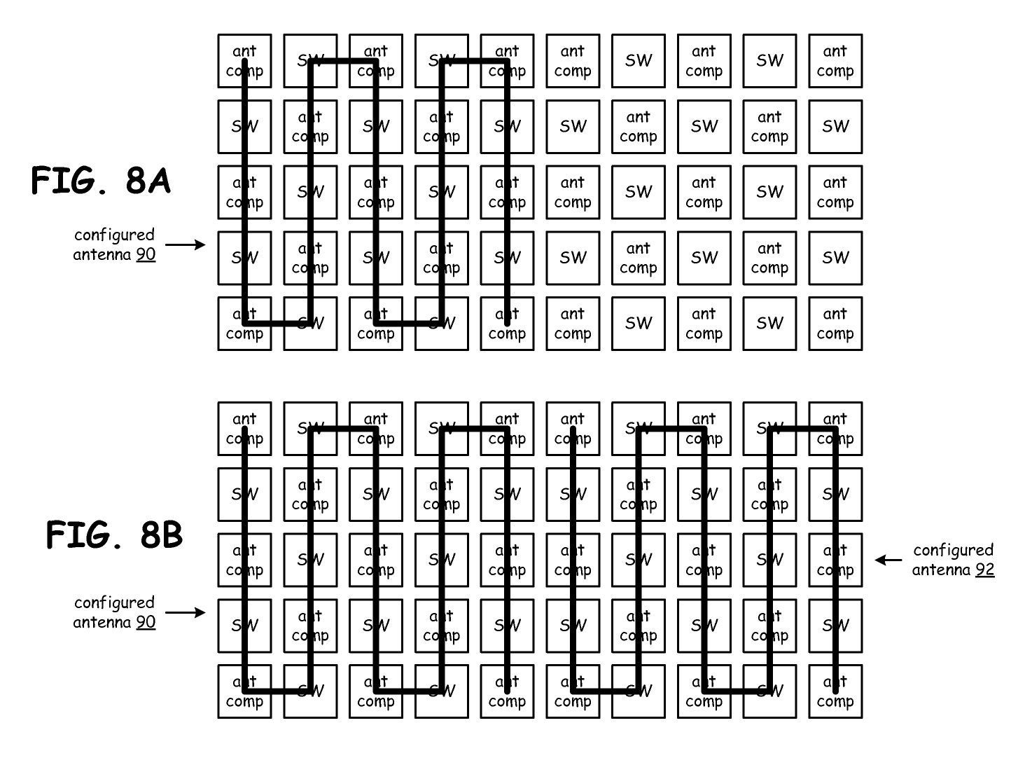

FIGS. 8A and 8B are diagrams illustrating configured antennas in accordance with one or more embodiments of the present invention. FIG. 8A is a diagram of an example of a configured antenna 90 that includes a meandering pattern. In this example, multiple antenna components are coupled together via switches to provide the meandering pattern. The length of the antenna is dependent upon the frequency of operation. Other antenna properties are dependent upon the properties of the configured antenna components 24. In one implementation, the antenna is configured for a single frequency band, or portion thereof. In another implementation, the antenna is configured for multiple frequency bands.

FIG. 8B is a diagram of another example of a configured antenna that includes two meandering trace antennas 90 and 92. In this example, two meandering antennas are created of approximately the same length. One may be used for transmitting signals and the other may be used for receiving signals. Alternatively, the configured antennas 90 and 92 may have a different length (and other differing antenna properties) to transmit and/or receive signals in different frequency bands, or different channels in different frequency bands. As a further alternative, one configured antenna may have a meandering pattern while the second may have another antenna configuration (e.g., mono pole, di-pole, helical, etc.). In an implementation, the two or more configured antennas may be used in concert for beamforming and/or for a multiple input multiple output (MIMO) communication. In another implementation, the two or more configured antennas may be used to form a diversity antenna structure.

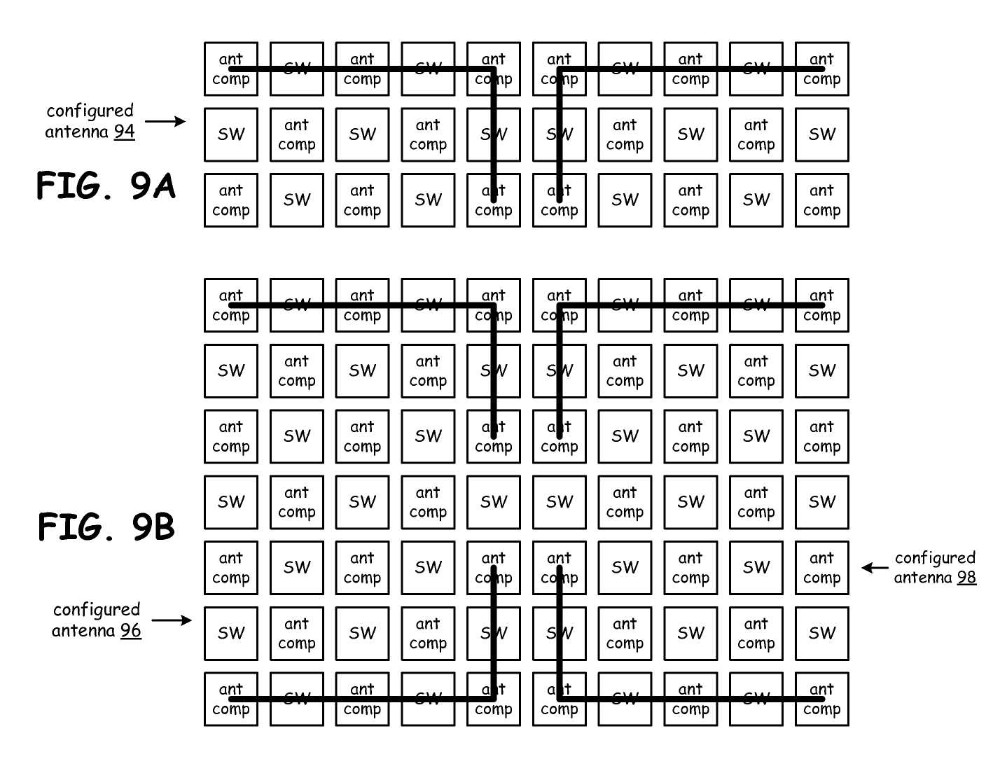

FIGS. 9A and 9B are diagrams illustrating configured antennas in accordance with one or more embodiments of the present invention. FIG. 9A is a diagram of another example of a configured antenna 94 that has a di-pole configuration. In this example, the antenna elements are configured in a mirroring image to provide the configured di-pole antenna. The length (and potentially other properties of the antenna) of the di-pole antenna is based on the desired frequency band, or portion thereof.

FIG. 9B is a diagram of another example of a configured antenna that includes two di-pole antennas 96 and 98. The two configured di-pole antennas may operate in the same frequency band or different frequency bands, may be have the same or different polarization, and/or may have the same or different antenna properties. In an implementation, one antenna may be used for transmitting signals and the other for receiving signals. In another implementation, the two or more configured antennas may be used in concert for beamforming and/or for a multiple input multiple output (MIMO) communication. In yet another implementation, the two or more configured antennas may be used to form a diversity antenna structure.

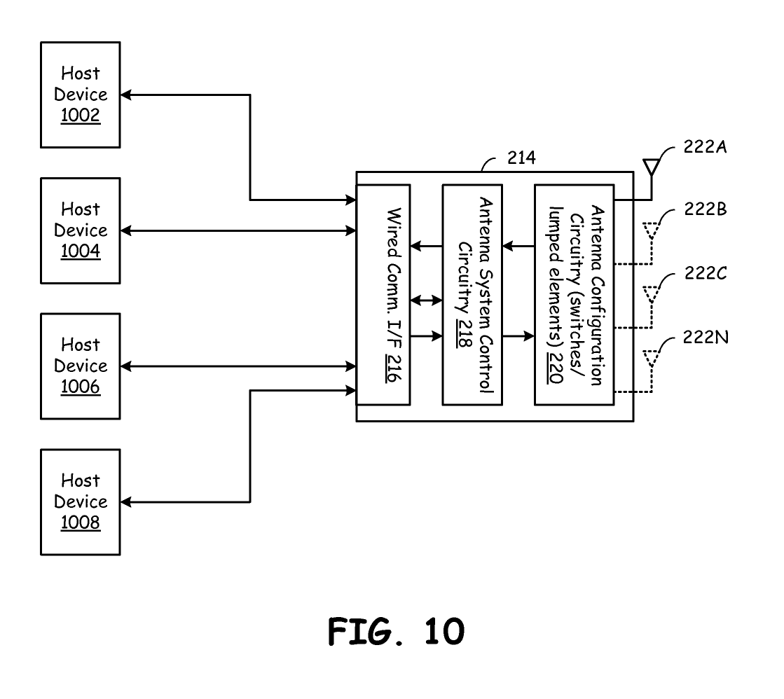

FIG. 10 is a block diagram illustrating an antenna system constructed according to the present invention that services a plurality of host devices. Numbering of FIG. 10 is consistent with that of FIG. 2A for simplicity. However, the various embodiments of the antenna system of FIGS. 2B and 2C may also be included to service multiple host devices at a single time. With the embodiment of FIG. 10, the antenna system 214 services host devices 1002, 1004, 1006, and 1008 via a single wired communications interface 216. For example, the wired communications interface 216 may include a USB hub and/or may include a multiplexed/multi-port serial or parallel interface to communicate with the plurality of host devices 1002, 1004, 1006, and 1008. For example, when the antenna system 214 is installed in the structure of a vehicle or a building, multiple users may desire to use the antenna system 214 to reap the benefits provided thereby of better performance and lower power consumption. Since the structure of the building or vehicle may service a plurality of users, the antenna system may beneficially service the plurality of users. Further, it may be the case that a single user has a plurality of host devices 1002, 1004, 1006, and 1008 that is desirous of service by the antenna system 214. In such case, the single user may use the antenna system to service the plurality of host devices. This example may occur where the antenna system is worn by the user but the user has a plurality of host devices coupled thereto that are serviced by the antenna system.

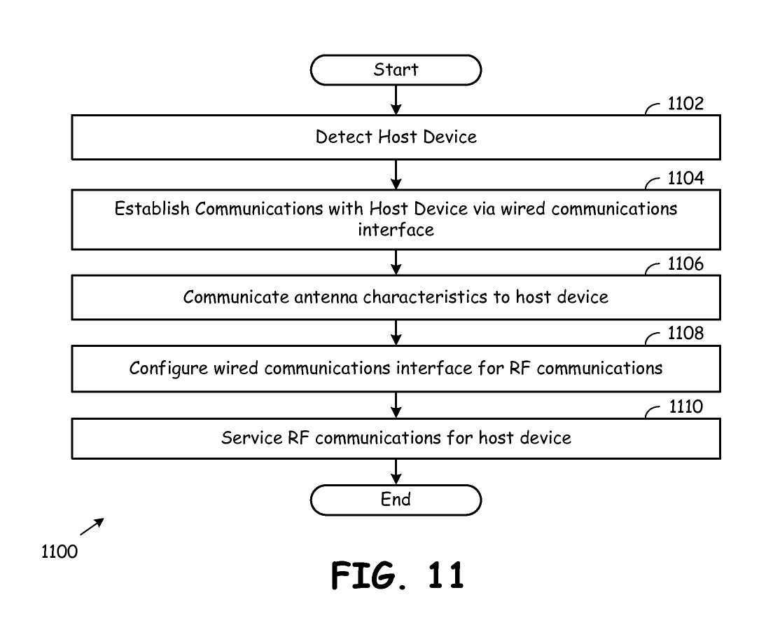

FIG. 11 is a flow chart illustrating operation of an antenna system according to an embodiment of the present invention. Operations 1100 commence with the antenna system detecting the presence of a host device (Step 1102). The antenna system then establishes communications with the host device via the wired communications interface (Step 1104). The antenna system control circuitry of the antenna system then communicates antenna characteristics to the host device via the wired communications interface (Step 1106). Based upon the communications with the host device, the antenna system control circuitry then configures the wired communications interface for RF communications (Step 1108). As was previously described herein, the antenna system may not service RF communications for the host device, may sometimes service RF communications for the host device, or may always service RF communications for the host device. In such case, at Step 1108, the wired communications interface is configured based upon the particular service of the antenna system. The antenna system then services the RF communications for the host device (Step 1110). From Step 1110, operation ends.

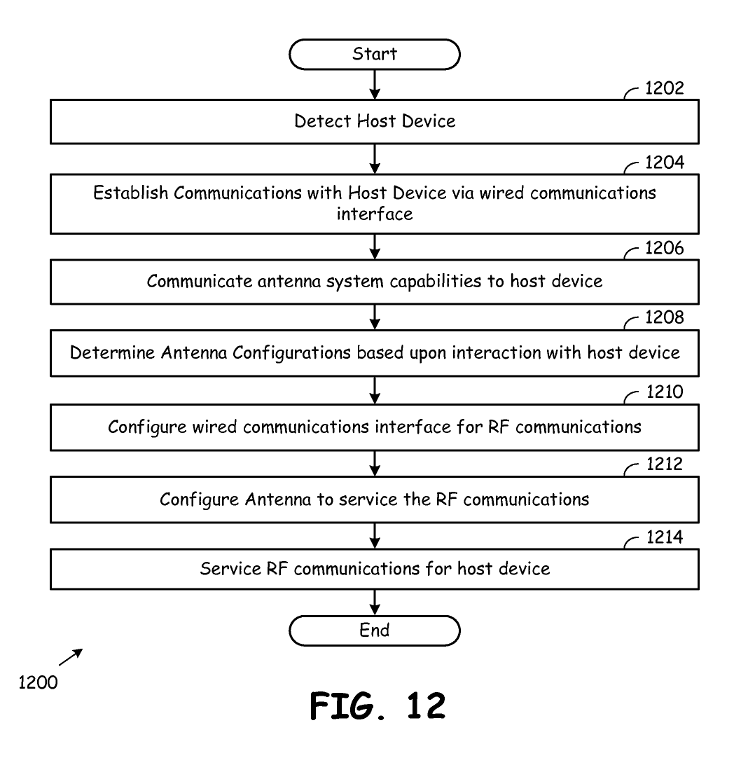

FIG. 12 is a flow chart illustrating operation of an antenna system according to another embodiment of the present invention. Operations 1200 commence with the antenna system detecting the presence of a host device via the wired communications interface (Step 1202). The antenna system then establishes communications with the host device via the wired communications interface (Step 1204). The antenna system via its antenna system control circuitry and the wired communications interface then communicates the antenna systems capabilities to the host device (Step 1206). Then, based upon interaction with the host device, the antenna system determines antenna configurations to be employed (Step 1208). The antenna system then configures the wired communications interface for RF communications to be serviced (Step 1210). The antenna system then configures its antenna for servicing of the RF communications (Step 1212). Configuration of the antenna may be performed via the various embodiments described with reference to FIGS. 6A-9B. Then, the antenna system services RF communications for the host device (Step 1214). From Step 1214, operation ends.

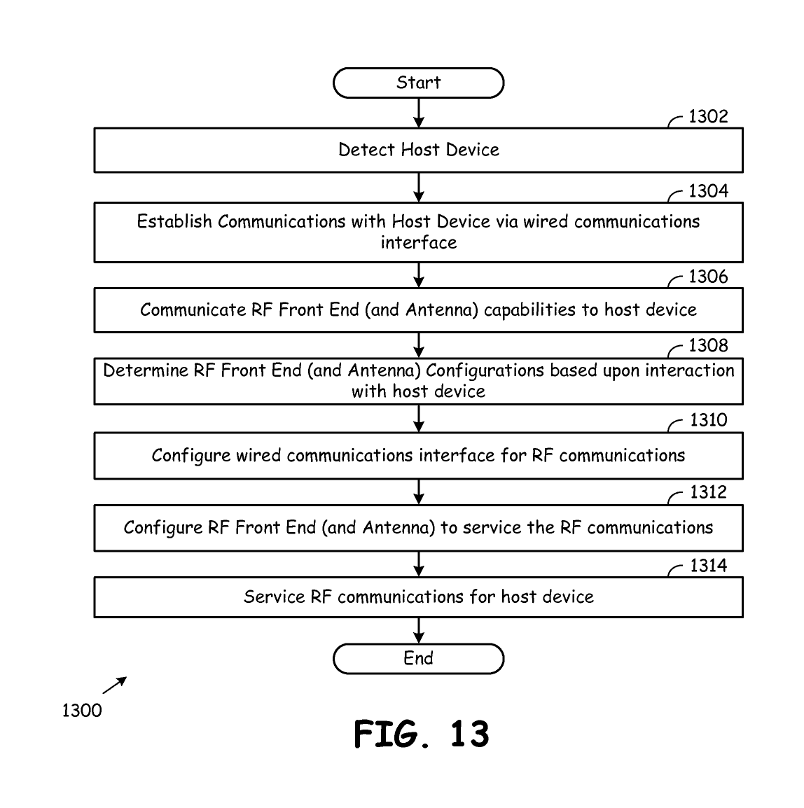

FIG. 13 is a flow chart illustrating operation of an antenna system according to yet another embodiment of the present invention. Operations 1300 commence with the antenna system detecting the presence of a host device (Step 1302). Such detection may occur when the antenna system is initially plugged into the host device. In most embodiments, the antenna system receives power from the host device via an empowered wired communications interface of the host device. For example, USB hubs or USB ports generally provide power to a peripheral device, such embodiment, via antenna system receiving power from the USB port.

Operation continues with the antenna system establishing communications of the host device via the wired communications interface (Step 1304). The antenna system then communicates its RF front-end and antenna capabilities to the host device (Step 1306). The capabilities of the antenna system are based upon its components and its abilities to configure the components. For example, as was illustrated in FIG. 2B and described with reference thereto, the antenna system included a receiver section of the transmitter section. In these embodiments, the receiver section and the transmitter section were also configurable in operation and were enabled so that they could service communications for the host device. Further, as was previously described, the antenna of the antenna system may be configured to have particular gain and bandwidth operational characteristics. These characteristics are communicated to the host device at Step 1206.

Then, the antenna system determines its RF front-end and antenna configurations based upon the interaction with host device as had at Step 1306 (Step 1308). The antenna system then continues its wired communications interface for RF communications (Step 1310). Then, the antenna system configures its RF front-end and/or antenna to service the RF communications as agreed with the host device (Step 1312). The antenna system then services the RF communications for the host device (Step 1314). From Step 1314, operation ends.

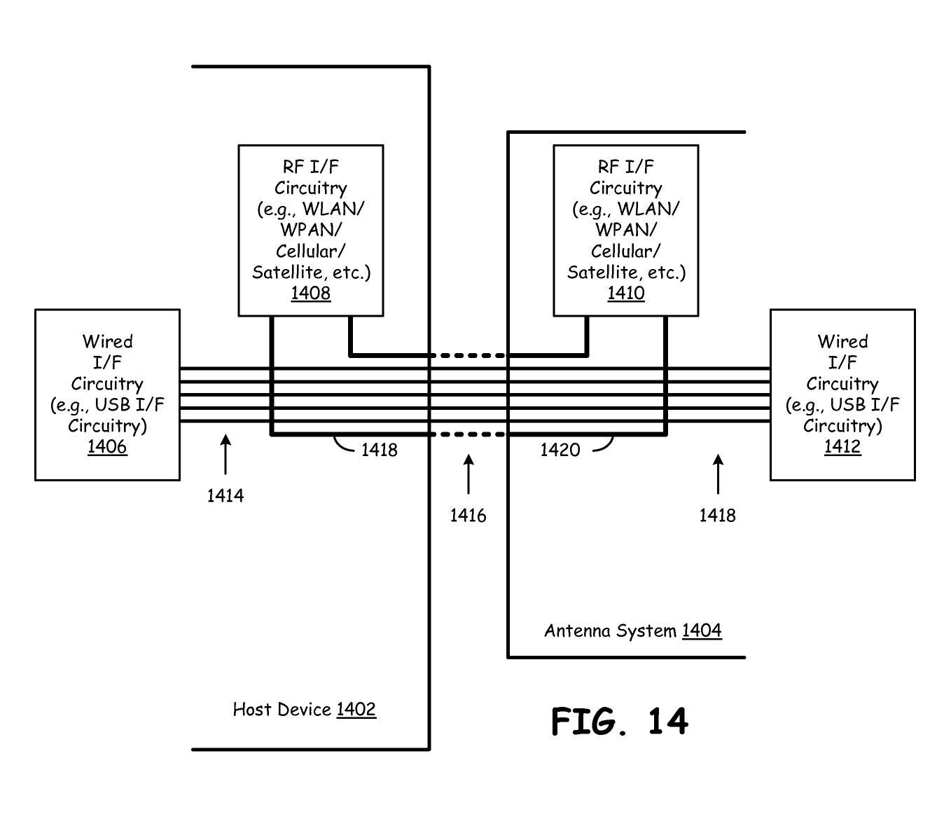

FIG. 14 is a block diagram illustrating structure for coupling RF signals between a host device and an antenna system according to one or more embodiments of the present invention. The host device 1402 includes wired interface circuitry 1406 that communicates with wired interface circuitry 1412 of the antenna system 1404. Connection 1416 between the host device 1402 and the antenna system 1404 includes wired connections that enable communications between the wired interface circuitry 1406 and the wired interface circuitry 1412. The wired connections 1416 of the connection 1416 may be consistent with standardized interface structure such as the USB interface, the Firewire interface, or another standardized interface. Thus, according to the embodiment of FIG. 14 standardized communications may be supported. Wired connections 1414 within the host device 1402 and wired connections 1418 within the antenna system 1404 service such communications. The connection 1416 may include a male portion of the antenna interface 1404 and a female portion of the host device 1402.

The connection 1416 also includes a waveguide component formed of a high quality metal sufficient to direct RF signals between the host device 1402 and the antenna system 1404. The host device 1402 includes a wave guide 1418 that couples the RF signals from/to RF interface circuitry 1408 and the antenna system 1404 includes a wave guide 1420 that couples the RF signals from/to RF interface circuitry 1408. Thus, with the embodiment of FIG. 14, wave guide coupling is available to service the communication of RF signals between the host device 1402 and the antenna system 1404 with minimum degradation.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip,” as used herein, refers to an integrated circuit. Circuits and circuitry may comprise general or specific purpose hardware, or may comprise such hardware and associated software such as firmware or object code.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to.” As may even further be used herein, the term “operable to” indicates that an item includes one or more of power connections, input(s), output(s), etc., to perform one or more its corresponding functions and may further include inferred coupling to one or more other items. As may still further be used herein, the term “associated with,” includes direct and/or indirect coupling of separate items and/or one item being embedded within another item. As may be used herein, the term “compares favorably,” indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. An antenna system comprising:
a wired communications interface operable to couple to a serviced host device, the wired communications interface including:
a control interface; and
an antenna interface;
an antenna coupled to the antenna interface, the antenna having configurable antenna characteristics; and
antenna system control circuitry coupled to the control interface and to the antenna and that is operable to:
communicate the configurable antenna characteristics to the host device; and
configure the antenna based upon communication with the host device.

2. The antenna system of claim 1, wherein:
the antenna comprises a plurality of antenna elements and a plurality of switches that are operable to inter couple the plurality of antenna elements into a plurality of differing configurations; and
the antenna system control circuitry is operable to control the plurality of switches to configure the antenna.

3. The antenna system of claim 2, wherein the antenna control circuitry configures the antenna based upon at least one frequency band of a plurality of information signal frequency bands supported by the host device.

4. The antenna system of claim 3, wherein the plurality of information signal frequency bands are selected from the group consisting of:
at least one Wireless Local Area Network (WLAN) frequency band;
at least one Wireless Personal Area Network (WPAN) frequency band;
at least one cellular frequency band;
at least one millimeter wave frequency band; and
at least one Global Positioning System (GPS) frequency band.

5. The antenna system of claim 1, wherein:
the antenna interface further comprises a switch; and
the antenna system control circuitry is operable to control the switch to selectively couple the antenna to the antenna interface.

6. The antenna system of claim 1, further comprising an amplifier operable to amplify a transmit signal received at the antenna interface.

7. The antenna system of claim 1, further comprising an amplifier operable to amplify a signal received by the antenna.

8. The antenna system of claim 1, wherein the antenna is constructed to be:
installed in the structure of a vehicle;
installed in the structure of a building; or
worn by a person.

9. The antenna system of claim 1, wherein the antenna interface comprises a wave guide.

10. An antenna system comprising:
a wired communications interface operable to couple to a serviced host device, the wired communications interface including:
a control interface; and
an antenna interface;
an antenna coupled to the antenna interface, the antenna having antenna characteristics; and
antenna system control circuitry coupled to the control interface that is operable to communicate the antenna characteristics to the host device via the control interface.

11. The antenna system of claim 10, wherein the antenna characteristics comprise frequency/gain characteristics of the antenna.

12. The antenna system of claim 10, further comprising an amplifier operable to amplify a transmit signal received at the antenna interface.

13. The antenna system of claim 10, further comprising an amplifier operable to amplify a signal received by the antenna.

14. The antenna system of claim 10, wherein the antenna system supports communications in a plurality of information signal frequency bands that are selected from the group consisting of:
at least one Wireless Local Area Network (WLAN) frequency band;
at least one Wireless Personal Area Network (WPAN) frequency band;
at least one cellular frequency band;
at least one millimeter wave frequency band; and
at least one Global Positioning System (GPS) frequency band.

15. The antenna system of claim 10, wherein the antenna is constructed to be:
installed in the structure of a vehicle;
installed in the structure of a building; or
worn by a person.

16. The antenna system of claim 10, wherein the antenna interface comprises a wave guide.

17. An antenna system comprising:
a wired communications interface operable to couple to a serviced host device, the wired communications interface including:
a control interface; and
an antenna interface;
an antenna;
Radio Frequency (RF) front end circuitry coupled to the antenna interface and to the antenna and operable to convert baseband/low IF signals to RF signals and to convert RF signals to baseband/low IF signals; and
antenna system control circuitry coupled to the control interface that is operable to:
communicate with the host device to report antenna system operational capabilities;
communicate with the host device to receive antenna system operational settings;
configure the RF front end circuitry based upon the antenna system operational settings.

18. The antenna system of claim 17, wherein the RF front end circuitry operates in each of an enabled mode and a disabled mode.

19. The antenna system of claim 17, wherein the antenna system supports communications in a plurality of information signal frequency bands that are selected from the group consisting of:
at least one Wireless Local Area Network (WLAN) frequency band;
at least one Wireless Personal Area Network (WPAN) frequency band;
at least one cellular frequency band;
at least one millimeter wave frequency band; and
at least one Global Positioning System (GPS) frequency band.

20. The antenna system of claim 17, the antenna system control circuitry further operable to:
communicate configurable antenna characteristics to the host device; and
configure the antenna based upon communication with the host device.

21. The antenna system of claim 20, wherein:
the antenna comprises a plurality of antenna elements and a plurality of switches that are operable to inter couple the plurality of antenna elements; and
the antenna system control circuitry is operable to control the plurality of switches to configure the antenna.

22. The antenna system of claim 20, wherein the antenna control circuitry configures the antenna based upon at least one frequency band of a plurality of information signal frequency bands supported by the host device.

23. The antenna system of claim 17, wherein:
the antenna interface further comprises a switch; and
the antenna system control circuitry is operable to control the switch to selectively couple the antenna to the antenna interface.

24. The antenna system of claim 17, wherein the antenna is constructed to be:
installed in the structure of a vehicle;
installed in the structure of a building; or
worn by a person.

25. The antenna system of claim 17, wherein the antenna interface comprises a wave guide.
